(19) United States
(12) Patent Application Publication
(10) Pub. No.: US 2016/0309420 A1
(43) Pub. Date: Oct. 20, 2016

(54) ADAPTATION OF TRANSMISSION POWER AND PACKET SIZE IN A WIRELESS DOCKING ENVIRONMENT

(71) Applicant: QUALCOMM Incorporated, San Diego, CA (US)

(72) Inventors: Lochan Verma, San Diego, CA (US); Olufunmilola Omolade Awoniyi-Oteri, San Diego, CA (US); Vijayalakshmi Rajasundaram Raveendran, San Diego, CA (US)

(21) Appl. No.: 14/811,645

(22) Filed: Jul. 28, 2015

Related U.S. Application Data
(60) Provisional application No. 62/148,126, filed on Apr. 15, 2015.

(51) Int. Cl. H04W 52/24; H04W 28/06; H04W 72/04

(52) U.S. Cl. CPC H04W 52/243; H04W 72/0473; H04W 28/06

(57) ABSTRACT

Various aspects describe adjusting the transmission power based on interference information, adjusting packet size when the measured error rate is different from the target error rate, and transmitting the packet according to the transmission power. Adjusting the transmission power may include increasing and/or decreasing the transmission power based on an interference margin report. Adjusting the transmission power may include increasing the transmission power when a measured link margin at a current transmission rate is greater than a target link margin at the current transmission rate and decreasing the transmission power when the measured link margin at the current transmission rate is less than the target link margin at the current transmission rate. Adjusting the packet size may include reducing the packet size when the measured error rate is greater than a target error rate and increasing the packet size when the measured error rate is less than the target error rate.

### CROSS-REFERENCE TO RELATED APPLICATION(S)

This application claims priority to and benefit of provisional patent application No. 62/148,126 filed in the United States Patent and Trademark Office on Apr. 15, 2015, the entire content of which is incorporated herein by reference.

### TECHNICAL FIELD

Aspects of the present disclosure relate, generally, to wireless docking and, more particularly, to adaptation of transmission power and packet size in a wireless docking environment.

### INTRODUCTION

Wireless communication networks are widely deployed to provide various communication services such as telephony, video, data, messaging, broadcasts, and so on. Recent interest has been directed toward wireless local area network (WLAN) connectivity, where a dockee, e.g., a mobile device, such as a cellular telephone, can utilize a WLAN interface to establish wireless communication links with one or more peripheral devices. Wireless docking environments may include docking stations, dockees, and peripheral devices. A dockee may be any device that is capable of docking to a docking station. The docking station may provide connectivity between the dockee and one or more peripheral devices. A peripheral device may be a mouse, a keyboard, a display, a printer, a camera, speakers, mass storage devices, media servers, sensors, and/or various other devices.

In existing systems, many docking stations may be located within the transmission range of each other. Signals transmitted by one docking station may interfere with signals transmitted by another docking station. In some circumstances, such interference may cause errors or failures in the transmitted signals, thereby requiring re-transmission of those signals, and thus increasing system latency. Existing systems can benefit from enhancements that overcome such limitations and improve the overall user experience.

### SUMMARY

The following presents a simplified summary of one or more aspects of this present disclosure, in order to provide a basic understanding of such aspects. This summary is not an extensive overview of all contemplated features of the invention, and is intended neither to identify key or critical elements of all aspects of the present disclosure nor to delineate the scope of any or all aspects of the invention. Its sole purpose is to present some concepts of one or more aspects of the present disclosure in a simplified form as a prelude to the more detailed description that is presented later.

In an aspect, the present disclosure provides a method of wireless communication by an apparatus. The method includes adjusting transmission power for the wireless communication based on interference information. The method also includes adjusting a size of a packet for transmission when a measured error rate is different from a target error rate. The method also includes transmitting the packet according to the transmission power.

In another aspect, the present disclosure provides an apparatus configured for wireless communication. The apparatus includes a memory, a transceiver, and at least one processor communicatively coupled to the memory and the transceiver. The at least one processor is configured to adjust transmission power for the wireless communication based on interference information. The at least one processor is further configured to adjust a size of a packet for transmission when a measured error rate is different from a target error rate. The at least one processor is further configured to utilize the transceiver to transmit the packet according to the transmission power.

In yet another aspect, the present disclosure provides a computer-readable medium comprising computer-executable code configured for adjusting transmission power for the wireless communication based on interference information. The computer-executable code is further configured for adjusting a size of a packet for transmission when a measured error rate is different from a target error rate. The computer-executable code is further configured for transmitting the packet according to the transmission power.

In a further aspect, the present disclosure provides an apparatus configured for wireless communication. The apparatus includes means for adjusting transmission power for the wireless communication based on interference information. The apparatus also includes means for adjusting a size of a packet for transmission when a measured error rate is different from a target error rate. The apparatus also includes means for transmitting the packet according to the transmission power.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the present disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a wireless docking environment according to aspects of the present disclosure.

FIG. 2 is a diagram illustrating another example of a wireless docking environment according to aspects of the present disclosure.

FIG. 3 is a diagram illustrating an example of various communications between two conventional devices.

FIG. 4 is a diagram illustrating an example of various communications between two devices according to aspects of the present disclosure.

FIG. 5 is a diagram illustrating another example of various communications between two devices according to aspects of the present disclosure.

FIG. 6 is a diagram illustrating yet another example of various communications between two devices according to aspects of the present disclosure.

FIG. 7 is a diagram illustrating examples of various methods and/or processes according to aspects of the present disclosure.

FIG. 8 is a diagram illustrating an example of a hardware implementation according to aspects of the present disclosure.

### DESCRIPTION OF SOME EXAMPLES

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

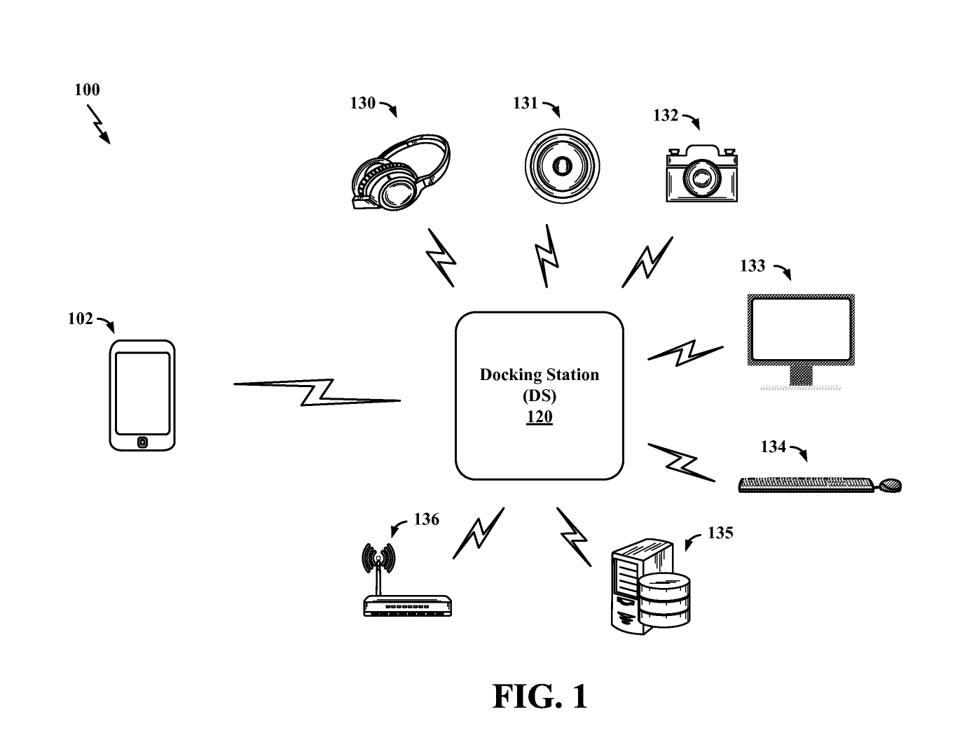

FIG. 1 is a diagram 100 illustrating an example of a wireless docking environment. The wireless docking environment may include a dockee 102 in communication with a docking station 120, and the docking station 120 may communicate with various peripheral devices. Generally, a docking station 120 is any apparatus that is configured to enable wireless docking of a dockee 102 according to aspects of the disclosure provided herein. Generally, a dockee 102 is any apparatus that is configured to wirelessly dock with a docking station 120 according to aspects of the present disclosure. Although the non-limiting example of the dockee 102 illustrated in FIG. 1 is a mobile device (e.g., a smartphone), one of ordinary skill in the art will understand that the dockee 102 may be a laptop computer, a tablet device, a wearable electronic device (e.g., a watch, glasses, etc.), and/or any other suitable apparatus without deviating from the scope of the present disclosure. Wireless docking may provide seamless connectivity, enabling two or more devices to connect together without needing wires, a docking connector, a personal identification number (PIN) code, elaborate pairing process for each peripheral device, nor other similar elements. Peripheral devices associated with the docking station 120 may act as a group. Many different types of peripheral devices may be supported, including bridging of legacy peripheral devices. Existing application sessions/connections may be left intact.

To establish a docking session, the docking station 120 and the dockee 102 may each receive and/or transmit various types of information. For example, the dockee 102 may transmit a probe request to the docking station 120. In response to the probe request, the docking station 120 may transmit a response message. Such exchanges of information may allow the dockee 102 to discover the docking station 120. The dockee 102 and the docking station 120 may also engage in various authentication/association exchanges. The dockee 102 and the docking station 120 may also engage in a handshake procedure as well as a channel establishment process. However, one of ordinary skill in the art will understand that every feature described in the above non-limiting example is not necessarily required and that alternative and/or additional features may be implemented without deviating from the scope of the present disclosure.

After the dockee 102 docks to the docking station 120, the docking station 120 may function as a relay station that relays information to and/or from the various apparatus docked and/or connected to the docking station 120. For example, referring to the non-limiting example illustrated in FIG. 1, the docking station 120 may relay user inputs received at a peripheral device (e.g., the keyboard and mouse 134) to the dockee 102. As another example, the docking station 120 may relay output signals from the dockee 102 to a peripheral device (e.g., an external display 133).

Various other peripheral devices may exist without deviating from the scope of the present disclosure. For example, in addition to the aforementioned external display 133 and keyboard and mouse 134, the peripheral devices may additionally or alternatively include headphones 130, external speakers 131, a camera 132, a computer 135, a base station 136, and/or various other suitable peripheral devices. The headphones 130 may be configured to communicate via a wired and/or wireless connection with the docking station 120. For example, the dockee 102 may transmit audio information (e.g., music, or other suitable sounds) to the docking station 120, and the docking station 120 may transmit the audio information to the headphones 130. In some configurations, the headphones may include a microphone (not shown). The microphone may be configured to capture audio information (e.g., speech, or other audio input) from a user. The microphone may transmit the audio information to the docking station 120, and the docking station 120 may transmit the audio information to the dockee 102 for various operations that will be readily apparent to one of ordinary skill in the art.

The external speakers 131 may be configured to communicate via a wired and/or wireless connection with the docking station 120. For example, the dockee 102 may transmit audio information (e.g., music, or other suitable sounds) to the docking station 120, and the docking station 120 may transmit the audio information to the external speakers 131. The external speakers 131 may be located in various locations without deviating from the scope of the present disclosure. For example, the external speakers 131 may be located on walls of an office conference room or walls of a residential living room.

The camera 132 may be configured to capture images and/or video. The camera 132 may be configured to communicate via a wired and/or wireless connection with the docking station 120. For example, the camera 132 may transmit image and/or video information to the docking station 120, and the docking station 120 may transmit the image and/or video data to the dockee 102 for various operations that will be readily apparent to one of ordinary skill in the art.

The computer 135 may be a personal computer, a enterprise/business computer, a network server, a database, a back-up/storage device, or any other suitable device. The computer 135 may be configured to communicate via a wired and/or wireless connection with the docking station 120. For example, information may be exchanged between the computer 135 and the docking station 120 as well as between the docking station 120 and the dockee 102.

In some configurations, the base station 136 may facilitate a wireless local area network (WLAN) in accordance with various communication protocols, such as the communication protocols of Institute of Electrical and Electronic Engineers (IEEE) 802.11. For example, the dockee 102 may utilize the base station 136 to access the Internet. In some other configurations, the base station 136 may provide high-speed data for mobile phones and data terminals. For example, the base station 136 may be an Evolved Node B (eNB) of an Evolved Universal Terrestrial Radio Access (E-UTRA) of a Long Term Evolution (LTE) communication system, or any other suitable communication system. The dockee 102 may exchange information with the base station 136 via the docking station 120 during operations that utilize the Internet.

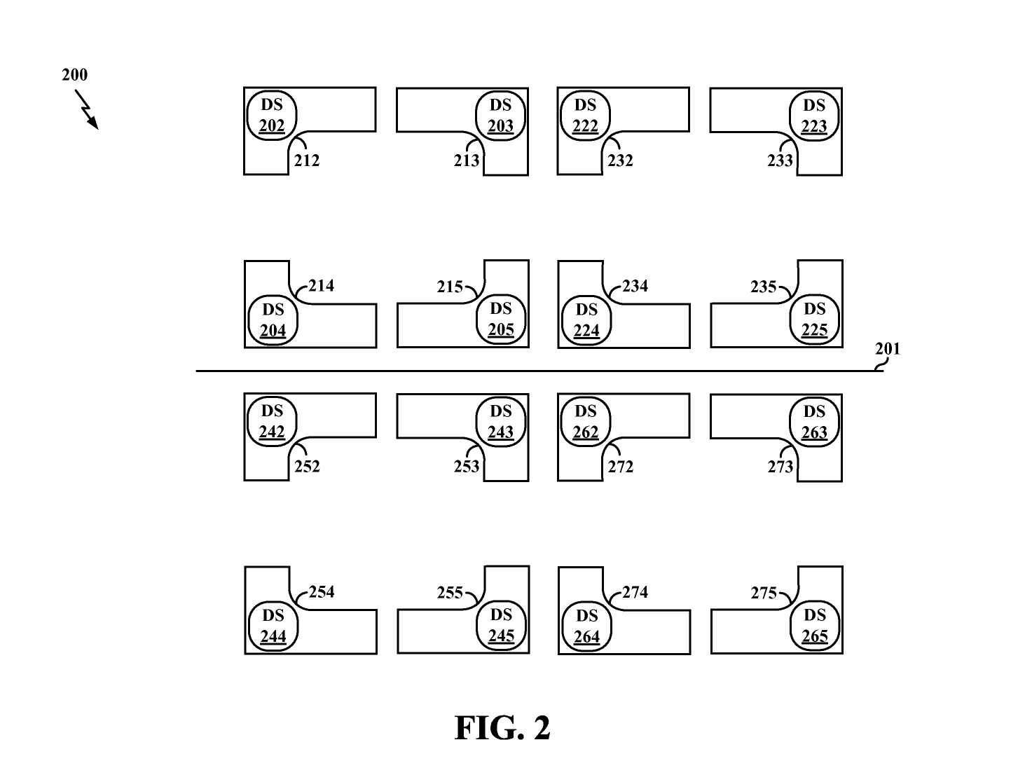

FIG. 2 is a diagram 200 illustrating another example of a wireless docking environment. More specifically, the diagram 200 illustrates an example of an enterprise docking environment. In some circumstances, the enterprise docking environment may be a dense docking environment. Generally, a dense docking environment may be characterized as an environment in which a plurality of docking stations (DS) are located within the transmission range and/or interference range of each other. Although various portions of the present disclosure may describe aspects pertaining to a ‘transmission range,’ one of ordinary skill in the art will understand that such aspects may also pertain to an ‘interference range’ without deviating from the scope of the present disclosure. In other words, in some configurations, the transmission range of a particular device may additionally or alternatively refer to the interference range of that device and, thus, such ‘transmission range’ and ‘interference range’ may be utilized interchangeably with regard to such configurations without deviating from the scope of the present disclosure. The plurality of docking stations may transmit signals that interfere with each other. In other words, the dense docking environment includes (at least) a first docking station and a second docking station, wherein the transmission range of the first docking station includes the second docking station and/or the transmission range of the second docking station includes the first docking station. Accordingly, transmissions from the first docking station may interfere with transmissions from the second docking station and/or signals transmissions from the second docking station may interfere with transmissions from the first docking station. In some examples, the physical distance between two or more docking stations may be approximately 2 to 6 meters. The physical distance between a particular docking station and its dockee(s) may be approximately 0.5 to 1.5 meters. However, one of ordinary skill in the art will understand that the distance between docking stations and the distance between a particular docking station and its dockee(s) may be less than or greater than the examples provided herein without deviating from the scope of the present disclosure.

The dense docking environment is located in an office or business environment. In the example illustrated in FIG. 2, the dense docking environment may include sixteen (16) office desks and sixteen (16) docking stations, wherein each of the office desks 212, 213, 214, 215, 232, 233, 234, 235, 252, 253, 254, 255, 272, 273, 274, 275 is associated with a separate docking station 202, 203, 204, 205, 222, 223, 224, 225, 242, 243, 244, 245, 262, 263, 264, 265, respectively. However, one of ordinary skill in the art will understand that a dense docking environment may include any plurality of docking stations without deviating from the scope of the present disclosure. The dense docking environment may sometimes include one or more walls 201, which may sometimes be referred to as ‘soft walls.’ Although such walls 201 may visually separate the physical space in which the docking stations are located, the transmissions from (at least) some of the docking stations may nonetheless penetrate such walls 201 and possibly interfere with transmissions from one or more other docking stations. For example, transmissions from a first docking station 204 may penetrate the wall 201 and possibly interfere with transmissions from a second docking station 242. Additionally, transmissions from the first docking station 204 may also possibly interfere with transmissions from other docking stations 202, 203, 205 located nearby it. Furthermore, the non-limiting example illustrated in FIG. 2 shows a topographic representation of a single layer of docking station (e.g., one floor of an enterprise office environment). One of ordinary skill in the art will appreciate that other layers of docking stations (e.g., other floors located above and below that one floor of an office or business environment), which may experience interference from (and/or be the source of interference to) the transmissions of the docking stations 202, 203, 204, 205, 222, 223, 224, 225, 242, 243, 244, 245, 262, 263, 264, 265 illustrated in FIG. 2. Accordingly, dense docking environments may present circumstances wherein interference-aware and/or interference-based adaptation procedures can enhance the user experience.

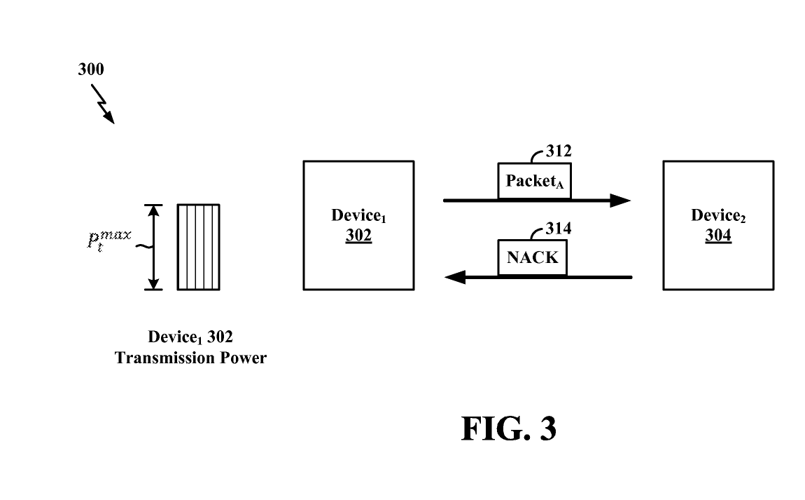

FIG. 3 is a diagram 300 illustrating an example of various communications between two conventional devices. In some configurations, a first conventional device (e.g., Device₁ 302) may be a docking station (e.g., the docking station 120 illustrated in FIG. 1), and a second conventional device (e.g., Device₂ 304) may be a dockee (e.g., the dockee 102 illustrated in FIG. 1). In some other configurations, the first conventional device (e.g., Device₁ 302) may be a dockee (e.g., the dockee 102 illustrated in FIG. 1), and the second conventional device (e.g., Device₂ 304) may be a docking station (e.g., the docking station 120 illustrated in FIG. 1). The maximum transmission power (Pₜ^{max}) of one of the conventional devices (e.g., Device₁ 302) may be preset. In some configurations, the maximum transmission power (Pₜ^{max}) may be preset by a system administrator. However, one of ordinary skill in the art will understand that the maximum transmission power (Pₜ^{max}) may be preset utilizing various other techniques without deviating from the scope of the present disclosure. Such a conventional device (e.g., Device₁ 302) may be unable to increase its transmission power beyond the power level corresponding to that preset maximum transmission power (Pₜ^{max}).

Even at the preset maximum transmission power (Pₜ^{max}), interference from other devices (e.g., other docking stations) may prevent or reduce the likelihood of the successful transmission of packets from one device (e.g., Device₁ 302) to another device (Device₂ 304) without error. Generally, a packet is a formatted unit of data that carries data from one device (e.g., Device₁ 302) to another device (Device₂ 304). The packet may include header information, control information, and/or payload information. The control information may include source and destination information for the packet, error detection codes, and sequencing information. The term ‘packet’ shall not be construed as a limitation of the present disclosure, as other suitable terms (e.g., data packet, network packet, etc.) may be utilized without deviating from the scope of the present disclosure.

Referring to FIG. 3, Device₁ 302 may transmit a packet (e.g., Packet_{A} 312) to Device₂ 304. However, in circumstances where interference from other devices (e.g., other docking stations) is relatively high, the Packet_{A} 312 may not successfully reach its destination without error. Accordingly, Device₂ 304 may receive Packet_{A} 312 in error. Because Packet_{A} 312 is received in error, Device₂ 304 may transmit a negative acknowledgement (NACK) 314, as illustrated in FIG. 3. Thus, in circumstances where interference from other devices (e.g., other docking stations) is relatively high, Device₁ 302 may be unable to transmit a packet (e.g., Packet_{A} 312) at the preset maximum transmission power (Pₜ^{max}).

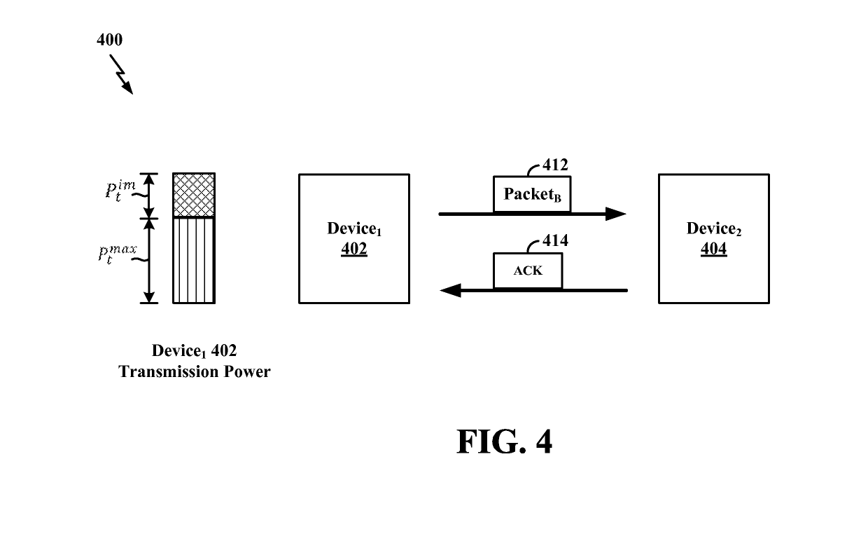

FIG. 4 is a diagram 400 illustrating an example of various communications between two devices according to various aspects of the present disclosure. In some configurations, a first device (e.g., Device₁ 402) may be a docking station (e.g., the docking station 120 illustrated in FIG. 1), and a second device (e.g., Device₂ 404) may be a dockee (e.g., the dockee 102 illustrated in FIG. 1). In some other configurations, the first device (e.g., Device₁ 402) may be a dockee (e.g., the dockee 102 illustrated in FIG. 1), and the second device (e.g., Device₂ 404) may be a docking station (e.g., the docking station 120 illustrated in FIG. 1). The maximum transmission power (Pₜ^{max}) of one of the devices (e.g., Device₁ 402) may be preset. In some configurations, the maximum transmission power (Pₜ^{max}) may be preset by a system administrator. However, one of ordinary skill in the art will understand that the maximum transmission power (Pₜ^{max}) may be preset utilizing various other techniques without deviating from the scope of the present disclosure. Although some conventional devices (e.g., Device₁ 302 illustrated in FIG. 3) may be unable to increase its transmission power beyond the power level corresponding to that preset maximum transmission power (Pₜ^{max}) a device (Device₁ 402) according to the present disclosure may be able to increase its transmission power beyond the preset maximum transmission power (Pₜ^{max}), as described in greater detail below.

In various aspects of the present disclosure, the device (Device₁ 402) may adjust the transmission power for the wireless communication based on interference information. In some configurations, the interference information is included in an interference margin report. Generally, an interference margin report includes information indicating the interference margin at the center frequency of at least one communication channel. As described in greater detail below (e.g., with reference to Equation 3), in some configurations, adjusting the transmission power may refer to increasing the transmission power for the wireless communication based on the interference margin. In some configurations, adjusting the transmission power may refer to decreasing the transmission power for the wireless communication based on the interference margin. The transmission power may be the maximum transmission power (Pₜ^{max}) that is preset by an administrator of the device (Device₁ 402). The term ‘adjusting’ shall not be construed narrowly based on any of the non-limiting examples provided herein. For example, adjusting may refer to adapting, altering, modifying, regulating, tuning, fine-tuning, customizing, increasing, decreasing, or in any way changing an aspect, feature, parameter, setting, or value pertaining to the transmission power without deviating from the scope of the present disclosure.

Generally, a ‘communication channel’ refers to a logical connection over a multiplexed medium, such as a radio channel The communication channel may be used to convey a signal, such as a digital bit stream, a packet, or other suitable information. The communication channel may have a capacity, which may sometimes be referred to as its bandwidth (in Hz) or its data rate (in per second). The communication channel may have a center frequency, which refers to the approximate frequency value that is approximately in the center of the bandwidth corresponding to that communication channel. Generally, the term ‘interference margin’ may correspond to the interference levels at various center frequencies of various communication channels. For instance, Device₁ 302 may measure the power of various signals received from other devices (e.g., Device₂ 304) at various center frequencies of various communication channels. Additional non-limiting examples pertaining to the interference margin are provided below.

In some embodiments, interference margin may refer to the interference detected at one apparatus (e.g., Device₁ 402) from transmissions of another device (e.g., Device₂ 404). In some other embodiments, the interference margin may refer to a difference between a maximum noise level (Nₘₐₓ) and a minimum noise level (Nₘᵢₙ) detected by the apparatus (e.g., Device₁ 402). For example, the interference margin (Iₘ^{c}) of a channel c with a bandwidth m may be defined by Equation 1.

Iₘ^{c}=Nₘₐₓ−Nₘᵢₙ (Equation 1)

In equation 1, Nₘₐₓ is the maximum noise in dBm, and Nₘᵢₙ is the minimum noise in dBm. The interference margin is a difference between the maximum noise and the minimum noise. The noise may be determined empirically or through measurements over a certain time window. Multiple measurements may be made and averaged to determine the average noise. In one particular example, the noise may be calculated as a function of bandwidth and temperature as defined in Equation 2.

Nₘᵢₙ=KBT (Equation 2)

In equation 2, K refers to the Boltzman Constant, B refers to bandwidth, and T refers to room temperature (in Kelvin). In some aspects of the disclosure, the device may measure the interference margins of different bandwidths (e.g., 40 MHz, 80 MHz, and 160 MHz). For each bandwidth, the device may measure the interference margin corresponding to a combination of one or more channels for providing that bandwidth.

Information pertaining to the interference margin may be organized into various tables. Non-limiting examples of such tables are provided in Tables 1-3.

TABLE 1
Interference Margin Profile Table
40 MHz Operation

| Communication Channel | Center Frequency | Interference Margin |
|---|---|---|
| (20 MHz each) | (MHz) | (dBm) |
| X | A | I_{A} |
| Y | B | I_{B} |

TABLE 2
Interference Margin Profile Table
80 MHz Operation

| Communication Channel | Center Frequency | Interference Margin |
|---|---|---|
| (40 MHz each) | (MHz) | (dBm) |
| X′ | A′ | I_{A′} |
| Y′ | B′ | I_{B′} |

TABLE 3
Interference Margin Profile Table
160 MHz Operation

| Communication Channel | Center Frequency | Interference Margin |
|---|---|---|
| (80 MHz each) | (MHz) | (dBm) |
| X″ | A″ | I_{A″} |
| Y″ | B″ | I_{B″} |

The interference margin at each communication channel may be determined using any suitable technique. For example, the interference margin I_{A} is the interference margin (in dBm) of a channel A with a 20 MHz bandwidth. Each device may generate such interference margin reports based on its own interference environment. Each of the interference margins in Tables 1-3 correspond to a certain combination of channels and bandwidths. In some examples, the available channels may be the channels available in certain WLAN networks (e.g., channels 1 through 15 in the 2.4 GHz band), and the available bandwidths may be 20 MHz, 40 MHz, 80 MHz, and 160 MHz. A 40 MHz channel may include any two aggregated (bonded) 20 MHz channels, an 80 MHz channel may include any two aggregated 40 MHz channels, and a 160 MHz channel may include any two aggregated 80 MHz channels. In some aspects of the present disclosure, the aggregated channels may be adjacent and/or contiguous channels.

After the interference margin report (e.g., Tables 1-3) is constructed, the device (e.g., Device₁ 402) may broadcast, publish, or transmit the report to other devices (e.g., Device₂ 404) within the communication range of that device (e.g., Device₁ 402). In addition, the device (e.g., Device₁ 402) may receive similar interference margin reports broadcasted from those other devices (e.g., Device₂ 404). The interference margin report generated by the device itself (e.g., Device₁ 402) may be referred to as local reports, and the interference margin reports received from other devices (e.g., Device₂ 404) may be referred to as global reports.

In various aspects of the present disclosure, the device (Device₁ 402) may adjust the transmission power for the wireless communication based on the interference margins at the center frequencies of various communication channels. In some configurations, the transmission power may be decreased based on the interference margins. Additionally or alternatively, in some configurations, the transmission power may be increased based on the interference margins. For example, the interference margins at the center frequencies of various communication channels may be converted (e.g., using a logarithmic function, as provided in Equation 2 above) and added to the maximum transmission power (Pₜ^{max}) as designated by Pₜ^{im} in FIG. 4. Such an adjustment of the transmission power may be performed utilizing Equation 3.

P′ₜ^{max}=Pₜ^{max}+10 log₁₀Iₘ^{C} (Equation 3)

As illustrated in Equation 3, the adjusted transmission power (P′ₜ^{max}) equals the sum of the maximum transmission power (e.g., as set by the system administrator) plus ten multiplied by the log (base 10) of the interference margin (Iₘ^{c}) of a channel c with a bandwidth m. After the transmission power is adjusted based on the interference margin, the device (e.g., Device₁ 402) may transmit a packet (e.g., Packet_{B} 412), as illustrated in FIG. 4, according to that adjusted transmission power. Because the transmission power was adjusted (e.g., increased), the likelihood that Packet_{B} 412 will be successfully received by Device₂ 404 without error will be higher than the likelihood of such an outcome without the adjusting of the transmission power (as described above with reference to FIG. 3). Accordingly, after Device₂ 404 successfully receives Packet_{B} 412, Device₂ 404 will transmit an acknowledgement (ACK) 414 to Device₁ 402.

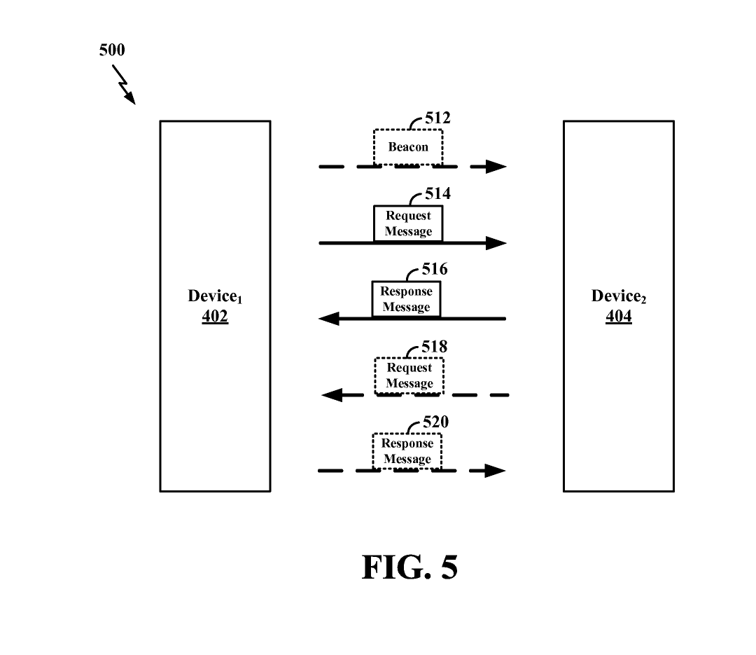

FIG. 5 is a diagram 500 illustrating another example of various communications between two devices, Device₁ 402 and Device₂ 404. Initially, Device₁ 402 may transmit (e.g., publish) a beacon 512 to other devices (e.g., Device₂ 404) within its transmission range. The beacon 512 may be transmitted (e.g., published) periodically. The beacon 512 may include a power constraint element and/or a transmit power control (TPC) report element. The power constraint element may include information necessary to allow a station, peer-to-peer, or other device to determine the local maximum transmission power (Pₜ^{max}) in a particular channel (e.g., the current channel). The TPC report element may include the transmit power (Pₜ) and the measured link margin (Lₘ) at the current transmission rate, as described in greater detail below. The TPC report element may be included in the beacon 512 or a probe request without a corresponding request. The link margin field may be reserved when the TPC report element is included in the beacon or probe response. Afterwards, the device joins the peer-to-peer-group operated by the docking station and initiates docking setup procedures, as described in greater detail above with reference to FIG. 1.

At a later time, Device₁ 402 transmits a request message 514, such as a TPC request message. The request message 514 may include information indicating the power at which the request message 514 was transmitted. For example, Device₁ 402 may include information indicating the power level at which the request message 514 will be transmitted. Subsequently, Device₁ 402 may transmit the request message 514 to other devices (e.g. Device₂ 404). After receiving the request message 514, Device₂ 404 may transmit a response message 516, such as a TPC response message. The response message 516 may indicate the power level at which the request message 514 was received by Device₂ 404. Device₁ 402 may calculate the measured link margin (Lₘ) at the current transmission rate by subtracting (i) the power level at which the request message 514 was transmitted (as indicated in the request message 514) by (ii) the power level at which the request message 514 was received at Device₂ 404 (as indicated in the response message 516). This procedure may be performed periodically by Device₁ 402.

Additionally or alternatively, a similar procedure may be performed by Device₂ 404, as illustrated in FIG. 5. In other words, Device₂ 404 may transmit a request message 518, as described in greater detail above, and Device₁ 402 may transmit a response message 520, as also described in greater detail above. Accordingly, Device₂ 404 may calculate the measured link margin (Lₘ) at the current transmission rate by subtracting (i) the power level at which the request message 518 was transmitted (as indicated in the request message 518) by (ii) the power level at which the request message 518 was received at the Device₁ 402 (as indicated in the response message 520).

Generally, the term ‘link margin’ may refer to a reduction or attenuation in power of an electromagnetic wave (e.g., the signal corresponding to the Packet_{B} 412) as it propagates through space. Link margin may be a component that is evaluated in the analysis and design of the link budget of wireless communication systems. Link margin may be caused by interference from transmissions of other devices as well as various other factors known to one of ordinary skill in the art. One of ordinary skill in the art will understand that various other terms may describe the aspects described herein with reference to the link margin. For example, link margin may sometimes be referred to as ‘path loss’ or ‘path attenuation’ without deviating from the scope of the present disclosure. The measured link margin may differ based on the transmission rate. Generally, the term ‘transmission rate’ may refer to a quantity of data (e.g., a number of bits, bytes, etc.) that are conveyed by a transmitter during a period of time. The transmission rate may also be referred to as the data rate, bit rate, and/or any other suitable term known to one of ordinary skill in the art without deviating from the scope of the present disclosure. As mentioned above, the measured link margin may differ for different transmission rates. That is, the measured link margin may be higher or lower based on the particular transmission rate.

In various aspects of the present disclosure, the device (Device₁ 402) may adjust the transmission power for the wireless communication based on interference information corresponding to the link margin. For example, the transmission power may be adjusted according to Equation 4.

Pₜ=α*(Pₜ^{max}−(Lₘ−L′ₘ))+β*P′ₜ) (Equation 4)

With regard to Equation 4, Pₜ refers to the adjusted (e.g., current) transmission power (in dBm), Pₜ^{max} refers to the maximum transmission power (in dBm), Lₘ refers to the measured link margin (in dB) at the current transmission rate, L′ₘ refers to the operating link margin (in dB) at the current transmission rate, P′ₜ refers to a previous (e.g., old) transmission power (in dBm), and α and β are mathematical coefficients. The mathematical coefficients α and β may be positive real numbers that have a sum of one (1). In other words, α=1−β and β=1−α. The operating link margin (L′ₘ) may be preselected, predetermined, or predefined (e.g., by the system administrator) for the system (e.g., the wireless docking environment that includes Device₁ 402 and Device₂ 404) with regard to various transmission rates. The operating link margin (L′ₘ) may sometimes be referred to herein as the ‘target link margin’ without deviating from the scope of the present disclosure.

In some configurations, Device₁ 402 may adjust the transmission power (Pₜ) of a signal (e.g., the signal corresponding to Packet_{B} 412, as illustrated in FIG. 4) by (i) increasing the transmission power (Pₜ) when the measured link margin (Lₘ) at the current transmission rate is greater than the target link margin (L′ₘ) at the current transmission rate and (ii) decreasing the transmission power when the measured link margin (Lₘ) at the current transmission rate is less than the target link margin (L′ₘ) at the current transmission rate. When the measured link margin (Lₘ) is greater than the target link margin (L′ₘ) with regard to a particular transmission rate, the system cannot “afford” more risk of transmission errors. Accordingly, when the measured link margin (Lₘ) is greater than the target link margin (L′ₘ) with regard to a particular transmission rate, the transmission power (Pₜ) is increased to reduce the likelihood of transmission errors (e.g., interference errors caused by interference). Conversely, when the measured link margin (Lₘ) is less than the target link margin (L′ₘ) with regard to a particular transmission rate, the system can “afford” more risk of transmission errors. Accordingly, when the link margin is less than the target link margin (L′ₘ) with regard to a particular transmission rate, the transmission power (Pₜ) is decreased to conserve power consumption.

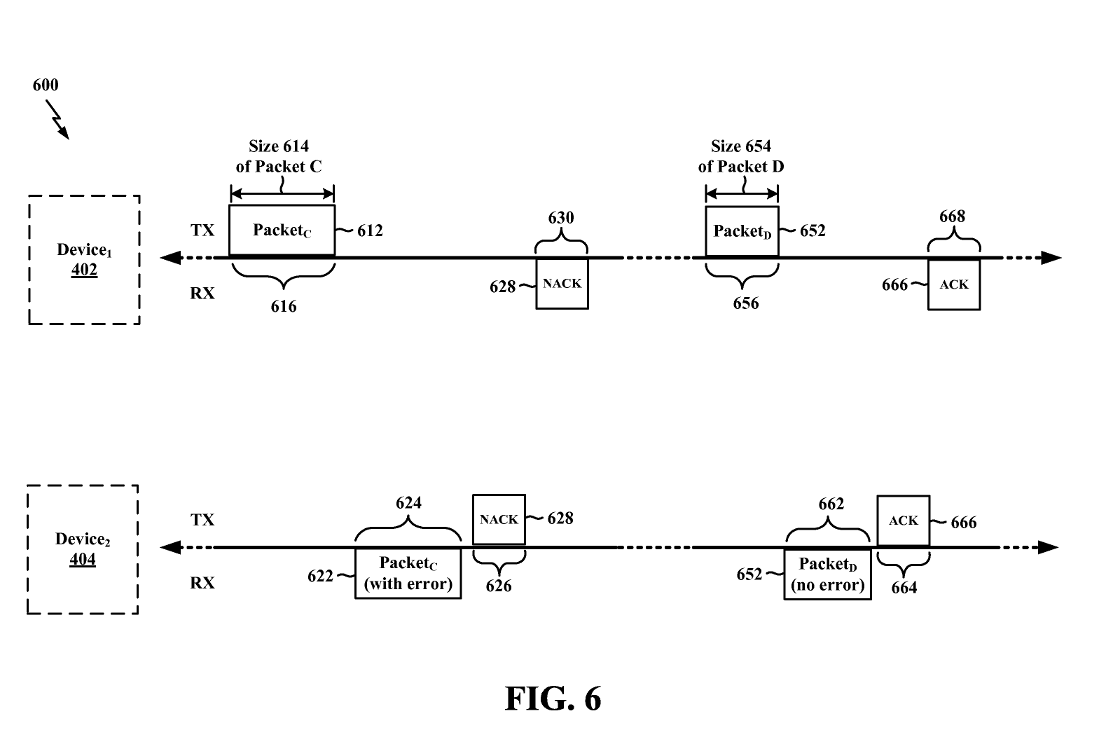

FIG. 6 is a diagram 600 illustrating yet another example of various communications between two devices, Device₁ 402 and Device₂ 404. In various aspects of the present disclosure, the size of the transmitted packet may be adjusted. As described in greater detail below, in some configurations, adjusting the size of the packet may refer to reducing the size of the packet when the measured error rate is greater than a target error rate and increasing the size of the packet when the measured error rate is less than the target error rate. The term ‘adjusting’ shall not be construed narrowly based on any of the non-limiting examples provided herein. For example, adjusting may refer to adapting, altering, modifying, regulating, tuning, fine-tuning, customizing, increasing, decreasing, or in any way changing an aspect, feature, parameter, setting, or value pertaining to the size of the packet without deviating from the scope of the present disclosure.

As described in greater detail above, generally, a packet is a formatted unit of data that carries data from one device (e.g., Device₁ 402) to another device (Device₂ 404). The packet may include header information, control information, and/or payload information. The term ‘packet’ shall not be construed as a limitation of the present disclosure, as other suitable terms (e.g., data packet, network packet, etc.) may be utilized without deviating from the scope of the present disclosure. Generally, the term ‘size’ may refer to the number of bits, bytes, or any other unit of data that may be included in various portions of the packet (e.g., the payload).

Generally, relatively smaller packets are more robust and are less likely to suffer from errors during packet transmission than relatively larger packets. In other words, relatively smaller packets are more robust and are less likely to suffer from errors during packet transmission than relatively larger packets. Accordingly, an adjustment of the size of the packet may affect the likelihood of error during packet transmission. One of ordinary skill in the art will understand that the size of the packet may be increased and/or decreased utilizing various method, techniques, or processes without deviating from the scope of the present disclosure. With regard to increasing the size of the packet, in some examples, the size of a packet may be increased by adding, inserting, or otherwise increasing the number of bits or bytes in the packet. In some other examples, the size of the packet may be increased by aggregating Media Access Control (MAC) Protocol Data Units (MPDUs). As such, the size of the Physical Layer Protocol Data Unit (PSDU) increases. With regard to decreasing the size of the packet, in some example, the size of the packet may be decreased by removing, omitting, or otherwise reducing the number of bits or bytes in the packet. In some other examples, the size of the packet may be decreased by fragmenting a MAC Service Data Unit (MSDU) and/or fragmenting an Aggregated MPDU (A-MPDU). As such, the size of the PSDU decreases. One of ordinary skill in the art will understand that, in some configurations, the ‘size’ of the packet may refer to the same concept as the ‘length’ of the packet. For example, the length of a packet may be increased by adding, inserting, or otherwise increasing the number of bits or bytes in the packet, and the length of the packet may be decreased by removing, omitting, or otherwise reducing the number of bits or bytes in packet.

Referring to FIG. 6, during a first time period 616, Device₁ 402 may transmit Packet_{C} 612, which has a particular size 614. In some circumstances, as discussed above in greater detail, interference from other devices (e.g., Device₂ 404) may result in errors during the transmission of a packet (e.g., Packet_{C} 612) from Device₁ 402 to Device₂ 404. In such circumstances, Device₂ 404 receives an erroneous Packet_{C} 622 during a subsequent time period 624. Because of the packet transmission was not successful (e.g. included errors), in some configurations, Device₂ 404 may transmit a NACK 628 during a next time period 626, and such a NACK 628 may be received by Device₁ 402 during a following time period 630.

In some other configurations, when the packet transmission is not successful (e.g., Packet_{C} 622 includes errors), Device₂ 404 may not necessarily transmit the aforementioned NACK 628. Some devices that comply with the communication standard IEEE 802.11 may not necessarily transmit a NACK. In such configurations, the absence of an ACK within a pre-defined or pre-determined period of time may be attributed as a NACK. For example, referring to FIG. 6, rather than transmitting the NACK 628, Device₂ 404 will not transmit an ACK (nor a NACK) for a period of time, and Device₁ 402 will attribute the absence of an ACK during that period of time as a NACK. That is, Device₁ 402 will determine that Packet_{C} 622 was received at Device₂ 404 with errors because no ACK was received within that aforementioned period of time.

As mentioned above, generally, relatively smaller packets are more robust and are less likely to suffer from errors during packet transmission than relatively larger packets. In other words, relatively smaller packets are more robust and are less likely to suffer from errors during packet transmission than relatively larger packets. Accordingly, an adjustment of the size of the packet may affect the likelihood of error during packet transmission. The transmitting device (e.g., Device₁ 402) may periodically or continuously measure, determine, or otherwise ascertain one or more error rates pertaining to packet transmissions during a period of time. A non-limiting example of such an error rate is a packet error ratio or a packet error rate (PER). Generally, the PER refers to the number of incorrectly received packets divided by the total number of received packets. A packet may be characterized as incorrectly received if at least one bit is erroneous. Various other error rates exist (e.g., bit error rate (BER), etc.) and may be utilized in addition or alternative to the PER without deviating from the scope of the present disclosure.

When a measured error rate (e.g. PER_{Current}) is less than a target error rate (e.g. PER_{Target}), the size of the packet may be increased. The size of the packet may be increased because, in view of the target error rate (e.g. PER_{Target}), the system can “afford” more risk of transmission errors. As described above, the risk of transmission errors is higher for relatively larger packets than relatively smaller packets. Conversely, when the measured error rate (e.g. PER_{Current}) is greater than the target error rate (e.g. PER_{Target}), the size of the packet may be reduced. The size of the packet may be reduced because, in view of the target error rate (e.g. PER_{Target}), the system cannot “afford” more risk of transmission errors. As described above, the risk of transmission errors is lower for relatively smaller packets than relatively larger packets. As illustrated in FIG. 6, Device₁ 402 can reduce the size of a future packet (e.g., Packet_{D} 652). In this example, Device₁ 402 generates Packet_{D} with a size 654 that is smaller than the size 614 of a previously generated packet (e.g., Packet_{C} 612, which had a larger size 614). During a subsequent time period 656, Device₁ 402 may transmit Packet_{D} 652. During a next time period 662, Device₂ 404 receives Packet_{D} 652 without error. Because the packet transmission was without error, Device₂ 404 transmits an ACK 666 at a time 664, which is received by Device₁ 402 at a following time 668.

In some configurations, the amount by which the size of the packet is reduced corresponds to an extent to which the measured error rate (e.g. PER_{Current}) is greater than the target error rate (e.g. PER_{Target}). In some configurations, the amount by which the size of the packet is increased corresponds to an extent to which the measured error rate (e.g. PER_{Current}) of the adjusted-sized packet is less than the target error rate (e.g. PER_{Target}). In other words, the size of the packet may be adjusted (e.g., increased and/or decreased) such that the difference between the target error rate (e.g. PER_{Target}) and the measured error rate (e.g. PER_{Current}) of the adjusted-sized packet is minimized (e.g., reduced to be as close as possible to zero).

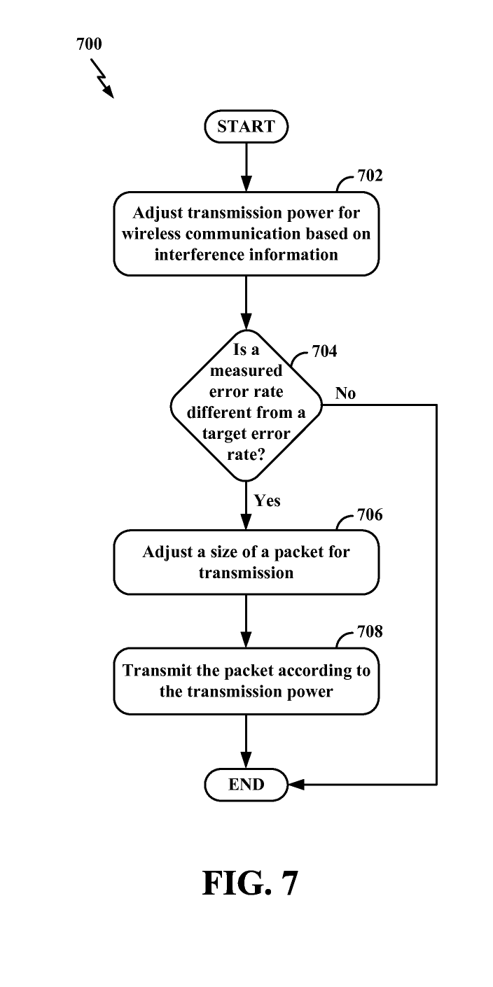

FIG. 7 is a diagram 700 illustrating an example of various methods and/or processes according to aspects of the present disclosure. Such methods and/or processes may be performed by any one or more of the devices described in greater detail in the present disclosure. At block 702, the device may adjust the transmission power for wireless communication based on interference information. In some configurations, the interference information may be included in an interference margin report, which includes the interference margins at center frequencies of one or more communication channels. In such configurations, the adjusting of the transmission power based on the interference margin report may include increasing the transmission power for the wireless communication based on the interference margin (e.g., adding power for the transmission in accordance with the interference margin included in the interference margin report). Additionally or alternatively, in such configurations, the adjusting of the transmission power may include decreasing the transmission power for the wireless communication based on the interference margin, or any other interference information. In some other configurations, the interference information corresponds to a link margin with regard to a particular transmission rate (e.g., a current transmission rate). The link margin may indicate a difference between a power at which a message is transmitted by the device and a power at which that message is received by another device. In such configurations, the device may increase the transmission power when the measured link margin at the current transmission rate is greater than the target link margin at the current transmission rate, and the device may decrease the transmission power when the measured link margin at the current transmission rate is less than the target link margin at the current transmission rate. Additional description pertaining to the foregoing features is provided in greater detail above and therefore will not be repeated here.

At block 704, the device may determine whether a measured error rate is different from a target error rate. As described in greater detail above, the target error rate may be the PER_{Target}, and the measured error rate may be the PER_{Current}. If the measured error rate is different from the target error rate, at block 706, the device may adjust a size of a packet for transmission. As described in greater detail above, generally, relatively smaller packets are more robust and are less likely to suffer from errors during packet transmission than relatively larger packets. In other words, relatively smaller packets are more robust and are less likely to suffer from errors during packet transmission than relatively larger packets. Accordingly, an adjustment of the size (or length) of the packet may affect the likelihood of error during packet transmission. The device may reduce the size of the packet when the measured error rate (e.g., PER_{Current}) is greater than the target error rate (e.g., PER_{Target}). Also, the device may increase the size of the packet when the measured error rate (e.g., PER_{Current}) is less than the target error rate (e.g., PER_{Target}). In some configurations, an amount by which the size of the packet is reduced corresponds to an extent to which the measured error rate is greater than the target error rate, and an amount by which the size of the packet is increased corresponds to an extent to which the measured error rate is less than the target error rate. Additional description pertaining to the foregoing features is provided in greater detail above and therefore will not be repeated here.

At block 708, the device may transmit the packet according to the transmission power. That is, the device transmits the packet, the size of which may possibly have been adjusted according to certain foregoing blocks 704, 706, with a transmission power that may have been adjusted according to another foregoing block 702.

One of ordinary skill in the art will appreciate that adjusting the transmission power together in combination with adjusting the packet size provides various advantages over merely adjusting the transmission power or merely adjusting the packet size. In other words, the combination of those adjustments provides advantages over performing either of those separately (i.e., not in combination with each other). For example, the transmission power cannot be infinitely reduced due to operating link margin requirements that may be set by the system administrator. Also, the transmission power cannot be infinitely increased due to maximum transmission power restrictions that may also be set by the system administrator. The system administrator may have set this maximum transmission power restriction in order to avoid or minimize the likelihood of a “domino-effect” wherein docking stations endlessly increase their respective transmission powers to avoid the effects of interference from other docking stations. Furthermore, adjusting the transmission power has some overhead costs associated with it. For example, adjusting the transmission power may require the exchange of various action frames. In comparison, adjusting the packet size does not require the exchange of such action frames. Even further, adjusting the transmission power is sometimes performed in increments (e.g., increments of 0.5 dB, 1 dB, etc.) and, thus, substantial adjustments to the transmission power may require a number of incremental adjustments, which together may require a substantial amount of time. In comparison, adjusting the packet size does not always have to be done in increments and, thus, the packet size can be adjusted in substantial amounts (e.g., 10 bytes, 20 bytes, etc.). Accordingly, in view of at least the foregoing reasons, one of ordinary skill in the art will understand that adjusting the transmission power in combination with adjusting the packet size is non-obvious and provides various technical advantages and overall improvements to the user experience.

One of ordinary skill in the art will understand that the sequence and order of operations described herein are provided for illustrative purposes and shall not be construed as a limitation of the present disclosure. In other words, although the examples provided herein describe that the transmission power is adjusted before the packet size is adjusted, one of ordinary skill in the art will understand that the packet size may be adjusted before the transmission power is adjusted without deviating from the scope of the present disclosure. The methods and/or processes described with reference to FIG. 7 are provided for illustrative purposes and are not intended to limit the scope of the present disclosure. The methods and/or processes described with reference to FIG. 7 may be performed in sequences different from those illustrated therein without deviating from the scope of the present disclosure. Additionally, some or all of the methods and/or processes described with reference to FIG. 7 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

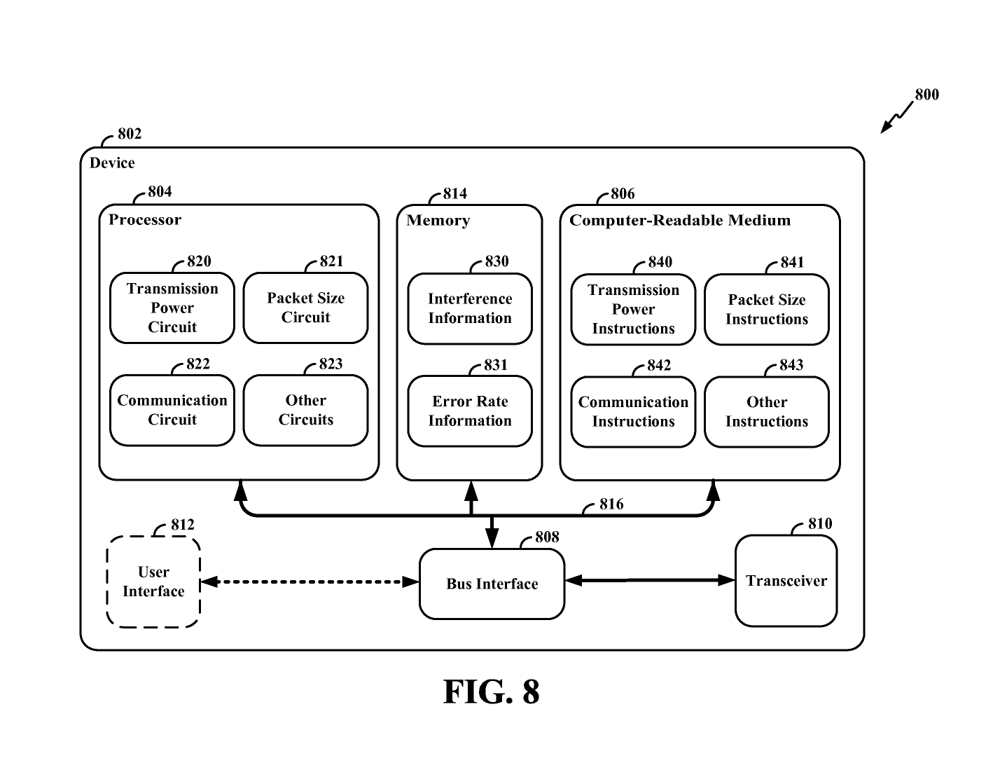

FIG. 8 is a diagram 800 illustrating an example of a hardware implementation of a device 802 in accordance with various aspects of the present disclosure. The device 802 may be the same as various other devices (e.g., Device₁ 402) described in greater detail herein. The device 802 may include a user interface 112. The user interface 112 may be configured to receive one or more inputs from a user of the device 802. The user interface 112 may also be configured to display information (e.g., text and/or images) to the user of the device 802. The user interface 112 may exchange data via the bus interface 808. The device 802 may also include a transceiver 810. The transceiver 810 may be configured to receive data and/or transmit data in communication with another apparatus. The transceiver 810 provides a means for communicating with another apparatus via a wired or wireless transmission medium. For example, the transceiver 810 may provide the means for establishing a wireless docking session with another apparatus and/or device. The transceiver 810 may be configured to perform such communications using various types of technologies. One of ordinary skill in the art will understand that many types of technologies may perform such communication without deviating from the scope of the present disclosure. The device 802 may also include a memory 814, one or more processors 804, a computer-readable medium 806, and a bus interface 808. The bus interface 808 may provide an interface between a bus 816 and the transceiver 810. The memory 814, the one or more processors 804, the computer-readable medium 806, and the bus interface 808 may be connected together via the bus 816.

The processor 804 may be communicatively coupled to the transceiver 810 and/or the memory 814. The processor 804 may include a transmission power circuit 820. The transmission power circuit 820 may include various hardware components and/or software modules that provide the means for adjusting transmission power for the wireless communication based on interference information. In some configurations, the means for adjusting the transmission power includes an algorithm that involves increasing and/or decreasing the transmission power for the wireless communication based on interference margins included in an interference margin report. In some other configurations, the means for adjusting the transmission power includes an algorithm that involves increasing the transmission power when the measured link margin at the current transmission rate is greater than a target link margin at the current transmission rate and decreasing the transmission power when the measured link margin at the current transmission rate is less than the target link margin at the current transmission rate. The processor 804 may also include a packet size circuit 821. The packet size circuit 821 may include various hardware components and/or software modules that provide the means for adjusting a size of a packet for transmission when the measured error rate is different from a target error rate. In some configurations, the means for adjusting the size of the packet includes an algorithm that involves reducing the size of the packet when the measured error rate is greater than a target error rate and increasing the size of the packet when the measured error rate is less than the target error rate. The processor 804 may also include a communication circuit 822. The communication circuit 822 may include various hardware components and/or software modules that provide the means for transmitting the packet according to the transmission power. The foregoing description provides a non-limiting example of the processor 804 of the device 802. Although various circuits have been described above, one of ordinary skill in the art will understand that the processor 804 may also include various other circuits 823 that are in addition and/or alternative(s) to circuits 820, 821, 822. Such other circuits 823 may provide the means for performing any one or more of the functions, methods, processes, features and/or aspects described herein.

The computer-readable medium 806 may include various instructions. The instructions may include computer-executable code configured to perform various functions and/or enable various aspects described herein. The computer-executable code may be executed by various hardware components (e.g., the processor 804) of the device 802. The instructions may be a part of various software programs and/or software modules. The computer-readable medium 806 may include transmission power instructions 840. The transmission power instructions 840 may include computer-executable code configured for adjusting transmission power for the wireless communication based on interference information. In some configurations, such computer-executable code is further configured for increasing and/or decreasing the transmission power for the wireless communication based on interference margins included in an interference margin report. In some other configurations, such computer-executable code is further configured for increasing the transmission power when the measured link margin at the current transmission rate is greater than the target link margin at the current transmission rate and decreasing the transmission power when the measured link margin at the current transmission rate is less than the target link margin at the current transmission rate. The computer-readable medium 806 may also include packet size instructions 821. The packet size instructions 821 may include computer-executable code configured for adjusting a size of a packet for transmission when the measured error rate is different from the target error rate. In some configurations, such computer-executable code is further configured for reducing the size of the packet when the measured error rate is greater than the target error rate and increasing the size of the packet when the measured error rate is less than the target error rate. The computer-readable medium 806 may also include communication instructions 842. The communication instructions 842 may include computer-executable code configured for transmitting the packet according to the transmission power. The foregoing description provides a non-limiting example of the computer-readable medium 806 of the device 802. Although various instructions (e.g., computer-executable code) have been described above, one of ordinary skill in the art will understand that the computer-readable medium 806 may also include various other instructions 843 that are in addition and/or alternative(s) to instructions 840, 841, 842. Such other instructions 843 may include computer-executable code configured for performing any one or more of the functions, methods, processes, features and/or aspects described herein.

The memory 814 may include various memory modules. The memory modules may be configured to store, and have read therefrom, various values and/or information by the processor 804, or any of its circuits 820, 821, 822, 823. The memory modules may also be configured to store, and have read therefrom, various values and/or information upon execution of the computer-executable code included in the computer-readable medium 806, or any of its instructions 840, 841, 842, 843. The memory 814 may include interference information 830. In some configurations, the interference information may be obtained from a margin interference report, as described in greater detail above. In some other configurations, the interference information may correspond to the measured link margin at a particular transmission rate, as also described in greater detail above. The memory 814 may also include error rate information 831. In some configurations, the error rate information 831 may include the measured error rate (e.g. PER_{Current}) and/or the target error rate (e.g., PER_{Target}), as described in greater detail above. Although various examples of information have been described above, one of ordinary skill in the art will understand that the memory 814 may also include various other information (not shown) that are in addition and/or alternative(s) to the aforementioned information 830, 831. Such other information (not shown) may include information performing any one or more of the functions, methods, processes, features and/or aspects described herein.

One of ordinary skill in the art will also understand that the device 802 may include alternative and/or additional features without deviating from the scope of the present disclosure. In accordance with various aspects of the present disclosure, an element, or any portion of an element, or any combination of elements may be implemented with a processing system that includes one or more processors 804. Examples of the one or more processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system may be implemented with a bus architecture, represented generally by the bus 816 and bus interface 808. The bus 816 may include any number of interconnecting buses and bridges depending on the specific application of the processing system and the overall design constraints. The bus 816 may link together various circuits including the one or more processors 804, the memory 814, and the computer-readable media 806. The bus 816 may also link various other circuits such as timing sources, peripherals, voltage regulators, and power management circuits, which are well known in the art.

The one or more processors 804 may be responsible for managing the bus 816 and general processing, including the execution of software stored on the computer-readable medium 806. The software, when executed by the one or more processors 804, causes the processing system to perform the various functions described below for any one or more apparatuses. The computer-readable medium 806 may also be used for storing data that is manipulated by the one or more processors 804 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 806. The computer-readable medium 806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 806 may also include, by way of example, a carrier wave, a transmission line, and any other suitable medium for transmitting software and/or instructions that may be accessed and read by a computer. The computer-readable medium 806 may reside in the processing system, external to the processing system, or distributed across multiple entities including the processing system. The computer-readable medium 806 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method of wireless communication by an apparatus, the method comprising:
adjusting a transmission power for the wireless communication based on interference information;
adjusting a size of a packet for transmission when a measured error rate is different from a target error rate; and
transmitting the packet according to the transmission power.

2. The method of claim 1, wherein:
the interference information is included in an interference margin report; and
the interference margin report comprise an interference margin at a center frequency of at least one communication channel.

3. The method of claim 2, wherein the adjusting the transmission power comprises:
increasing the transmission power for the wireless communication based on the interference margin.

4. The method of claim 2, wherein the adjusting the transmission power comprises:
decreasing the transmission power for the wireless communication based on the interference margin.

5. The method of claim 2, wherein the transmission power for the wireless communication is a maximum transmission power that is preset by an administrator of the apparatus.

6. The method of claim 1, wherein:
the interference information corresponds to a measured link margin at a current transmission rate; and
the measured link margin at the current transmission rate indicates a difference between a power at which a message is transmitted by the apparatus and a power at which the message is received at another apparatus.

7. The method of claim 6, wherein the adjusting the transmission power comprises:
increasing the transmission power when the measured link margin at the current transmission rate is greater than a target link margin at the current transmission rate; and
decreasing the transmission power when the measured link margin at the current transmission rate is less than the target link margin at the current transmission rate.

8. The method of claim 1, wherein the adjusting the size of the packet comprises:
reducing the size of the packet when the measured error rate is greater than a target error rate; and
increasing the size of the packet when the measured error rate is less than the target error rate.

9. The method of claim 8, wherein:
an amount by which the size of the packet is reduced corresponds to an extent to which the measured error rate is greater than the target error rate;
an amount by which the size of the packet is increased corresponds to an extent to which the measured error rate is less than the target error rate.

10. The method of claim 1, wherein the apparatus is located in a dense docking environment comprising a plurality of docking stations transmitting signals that interfere with each other.

11. An apparatus configured for wireless communication, the apparatus comprising:
a memory;
a transceiver; and
at least one processor communicatively coupled to the memory and the transceiver, the at least one processor configured to:
adjust a transmission power for the wireless communication based on interference information;
adjust a size of a packet for transmission when a measured error rate is different from a target error rate; and
utilize the transceiver to transmit the packet according to the transmission power.

12. The apparatus of claim 11, wherein:
the interference information is included in an interference margin report; and
the interference margin report comprise an interference margin at a center frequency of at least one communication channel.

13. The apparatus of claim 12, wherein the adjusting the transmission power comprises at least one of:
increasing the transmission power for the wireless communication based on the interference margin; or
decreasing the transmission power for the wireless communication based on the interference margin.

14. The apparatus of claim 13, wherein the transmission power for the wireless communication is a maximum transmission power that is preset by an administrator of the apparatus.

15. The apparatus of claim 11, wherein:
the interference information corresponds to a measured link margin at a current transmission rate; and
the measured link margin at the current transmission rate indicates a difference between a power at which a message is transmitted by the apparatus and a power at which the message is received at another apparatus.

16. The apparatus of claim 15, wherein the adjusting the transmission power comprises:
increasing the transmission power when the measured link margin at the current transmission rate is greater than a target link margin at the current transmission rate; and
decreasing the transmission power when the measured link margin at the current transmission rate is less than the target link margin at the current transmission rate.

17. The apparatus of claim 11, wherein the adjusting the size of the packet comprises:
reducing the size of the packet when the measured error rate is greater than a target error rate; and
increasing the size of the packet when the measured error rate is less than the target error rate.

18. The apparatus of claim 17, wherein:
an amount by which the size of the packet is reduced corresponds to an extent to which the measured error rate is greater than the target error rate;
an amount by which the size of the packet is increased corresponds to an extent to which the measured error rate is less than the target error rate.

19. The apparatus of claim 11, wherein the apparatus is located in a dense docking environment comprising a plurality of docking stations transmitting signals that interfere with each other.

20. A computer-readable medium comprising computer-executable code configured for:
adjusting a transmission power for the wireless communication based on interference information;
adjusting a size of a packet for transmission when a measured error rate is different from a target error rate; and
transmitting the packet according to the transmission power.

21. The computer-readable medium of claim 20, wherein:
the interference information is included in an interference margin report;
the interference margin report comprise an interference margin at a center frequency of at least one communication channel; and
the adjusting the transmission power comprises at least one of:
increasing the transmission power for the wireless communication based on the interference margin; or
decreasing the transmission power for the wireless communication based on the interference margin.

22. The computer-readable medium of claim 20, wherein:
the interference information corresponds to a measured link margin at a current transmission rate; and
the measured link margin at the current transmission rate indicates a difference between a power at which a message is transmitted by a first apparatus and a power at which the message is received at a second apparatus.

23. The computer-readable medium of claim 22, wherein the adjusting the transmission power comprises:
increasing the transmission power when the measured link margin at the current transmission rate is greater than a target link margin at the current transmission rate; and
decreasing the transmission power when the measured link margin at the current transmission rate is less than the target link margin at the current transmission rate.

24. The computer-readable medium of claim 20, wherein the adjusting the size of the packet comprises:
reducing the size of the packet when the measured error rate is greater than a target error rate; and
increasing the size of the packet when the measured error rate is less than the target error rate.

25. An apparatus configured for wireless communication, the apparatus comprising:
means for adjusting a transmission power for the wireless communication based on interference information;
means for adjusting a size of a packet for transmission when a measured error rate is different from a target error rate; and
means for transmitting the packet according to the transmission power.

26. The apparatus of claim 25, wherein the means for adjusting the transmission power is configured to at least one of:
increase the transmission power for the wireless communication based on the interference information; or
decrease the transmission power for the wireless communication based on the interference information.

27. The apparatus of claim 25, wherein:
the interference information corresponds to a measured link margin at a current transmission rate; and
the measured link margin at the current transmission rate indicates a difference between a power at which a message is transmitted by the apparatus and a power at which the message is received at another apparatus.

28. The apparatus of claim 27, wherein the means for adjusting the transmission power is configured to:
increase the transmission power when the measured link margin at the current transmission rate is greater than a target link margin at the current transmission rate; and
decrease the transmission power when the measured link margin at the current transmission rate is less than the target link margin at the current transmission rate.

29. The apparatus of claim 25, wherein the means for adjusting the size of the packet is configured to:
reduce the size of the packet when the measured error rate is greater than a target error rate; and
increase the size of the packet when the measured error rate is less than the target error rate.

30. The apparatus of claim 29, wherein:
an amount by which the size of the packet is reduced corresponds to an extent to which the measured error rate is greater than the target error rate;
an amount by which the size of the packet is increased corresponds to an extent to which the measured error rate is less than the target error rate.
